(19) United States
(12) Patent Application Publication
(10) Pub. No.: US 2012/0045388 A1
(43) Pub. Date: Feb. 23, 2012

(54) HYDROGEN GENERATION DEVICE AND HYDROGEN GENERATION METHOD

(75) Inventors: Cheng Wang, Hsinchu County (TW); Po-Kuei Chou, Hsinchu County (TW)

(73) Assignee: YOUNG GREEN ENERGY CO., Hsinchu County (TW)

(21) Appl. No.: 13/099,374

(22) Filed: May 3, 2011

(30) Foreign Application Priority Data
Aug. 18, 2010 (CN) 201010258192.8

(51) Int. Cl. C01B 3/04; H01M 8/06

(52) U.S. Cl. 423/648.1; 429/416; 429/421

(57) ABSTRACT

A hydrogen generation device including a tank, a porous structure, and a guide structure is provided. The tank is used to contain a reaction solution. A solid reactant is distributed in the porous structure. The guide structure is connected with the tank and used to guide the reaction solution in the tank to the porous structure, such that the reaction solution and the solid reactant react to generate hydrogen. A hydrogen generation method is also discussed.

### CROSS-REFERENCE TO RELATED APPLICATION

This application claims the priority benefit of China application serial no. 201010258192.8, filed on Aug. 18, 2010. The entirety of the above-mentioned patent application is hereby incorporated by reference herein and made a part of this specification.

### BACKGROUND OF THE INVENTION

1. Field of the Invention

The invention relates to a hydrogen generation device and a hydrogen generation method, and more particularly, to a hydrogen generation device using a solid reactant and a hydrogen generation method using a solid reactant.

2. Description of Related Art

A fuel cell (FC) is a power generation device capable of directly converting chemical energy into electricity. With advantages of low pollution, low noise, high energy density, and high energy conversion efficiency over the traditional electricity generation methods, the fuel cell is a prospective clean energy source.

Taking a proton exchange membrane FC as an example, the operation principle thereof is as follows. Hydrogen is oxidized in an anode catalyst layer to generate hydrogen ions (H⁺) and electrons (e⁻). The hydrogen ions can be transmitted to a cathode through a proton exchange membrane, and the electrodes are transmitted to a load through an external circuit for working, and then are transmitted to the cathode. Oxygen supplied to the cathode, the hydrogen ions, and the electrodes may have a reduction reaction in a cathode catalyst layer to generate water. The fuel hydrogen gas for the anode hydrogen oxidation reaction may be obtained through a hydrogen storage technology by using the solid sodium borohydride (NaBH₄) which relies on the reaction of water and the solid NaBH₄ to produce the hydrogen gas.

To reduce a size of the reactant, the solid NaBH₄ is pressed as a tablet. Water would slowly enter the tablet-form solid NaBH₄ by way of infiltration. When the water supply is insufficient, the water is only reacted on the surface of the tablet-form solid NaBH₄ without infiltrating inside the solid NaBH₄, which may reduce a hydrogen generation efficiency. Moreover, the generated hydrogen may bubble the surface of the solid NaBH₄, which hinders the water to enter the interior of the solid NaBH₄. Furthermore, when water reacts with the NaBH₄, the tablet-form NaBH₄ tends to expand and deform due to the generated gas.

Taiwan Patent Publication Nos. TW200738890 and TW200640072 and U.S. Pat. No. 7,674,540 disclose technologies relating to the fuel cell.

### SUMMARY OF THE INVENTION

Accordingly, the invention is directed to a hydrogen generation device which may enhance the generation efficiency of hydrogen formed by a reaction of the solid reactant and reaction solution.

The invention is also directed to a hydrogen generation method which may enhance the generation efficiency of hydrogen formed by a reaction of the solid reactant and the reaction solution.

To achieve one of or all aforementioned and other advantages, an embodiment of the invention provides a hydrogen generation device including a tank, a porous structure, and a guide structure. The tank is used to contain a reaction solution. A solid reactant is distributed in the porous structure. The guide structure is connected with the tank and used to guide the reaction solution in the tank to the porous structure, such that the reaction solution reacts with the solid reactant to generate hydrogen.

To achieve one of or all aforementioned and other advantages, an embodiment of the invention provides a hydrogen generation method. The method includes providing a porous structure with a solid reactant distributed in the porous structure; and guiding the reaction solution to the porous structure such that the solid reactant reacts with the reaction solution to generate hydrogen.

In view of the foregoing, in embodiments of the invention, the reaction solution is guided to the porous structure through the guide structure such that the reaction solution can directly react with the solid reactant distributed in the porous structure thus enhancing the hydrogen generation efficiency. Besides, the generated hydrogen could escape directly through the pores of the porous structure for a fuel cell to generate electricity.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 illustrates a hydrogen generation device according to one embodiment of the invention.

FIG. 2 illustrates a hydrogen generation device according to another embodiment of the invention.

FIG. 3A is a flow chart of a hydrogen generation method.

FIGS. 3B to 3C illustrate a process of generating hydrogen by the hydrogen generation device of FIG. 1.

FIGS. 3D to 3E illustrate a process of distributing the solid reactant in the porous structure.

FIGS. 4A and 4B illustrates another process of generating hydrogen by the hydrogen generation device of FIG. 1.

FIGS. 4C and 4D illustrate a process of distributing a solid catalyst in the porous structure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

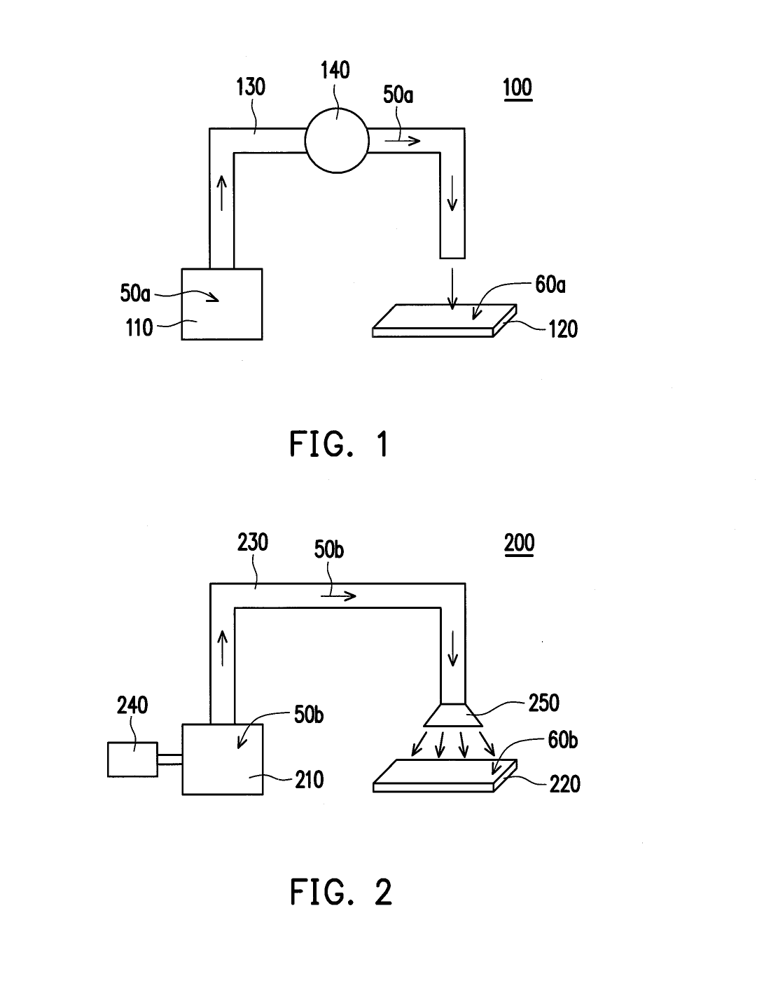

FIG. 1 illustrates a hydrogen generation device according to one embodiment of the invention. Referring to FIG. 1, the hydrogen generation device 100 of the embodiment includes a tank 110, a porous structure 120, and a guide structure 130. The tank 110 is used to contain a reaction solution 50a. A solid reactant 60a, such as sodium borohydride (NaBH₄), solid magnesium hydride (MgH₂), calcium hydride (CaH₂), or aluminium (Al), in the form of powder, particle, crystal or other forms is distributed in the porous structure 120 (e.g. in pores of the porous structure 120, where the diameter of the pores ranges from 5 um to 200 um). An example of the porous structure 120 is expanded polymer, such as expanded polyurethane. The guide structure 130 is connected with the tank 110 and disposed between the tank 110 and the porous structure 120, for guiding the reaction solution 50a in the tank 110 to the porous structure 120. As such, when the reaction solution 50a is guided to the porous structure 120, the reaction solution 50a could directly react with the solid reactant 60a distributed in the porous structure 120, thus enhancing the hydrogen generation efficiency.

Specifically, the solid reactant 60a is uniformly distributed in the pores of the porous structure 120, and the reaction solution 50a could be guided to the porous structure 120 through the guide structure 130. Due to permeation effect, the reaction solution 50a is delivered from the surface of the porous structure 120 into pores of the porous structure 120 to react with the solid reactant 60a in the pores. The hydrogen generation efficiency is thus enhanced because of the increased contact surface between the reaction solution 50a and the solid reactant 60a. The pores of the porous structure 120 may act as gas passages. Therefore, the generated hydrogen could escape directly through the pores of the porous structure 120 for a fuel cell to generate electricity. Furthermore, because the hydrogen is delivered through the pores, the expansion and deformation of the porous structure 120 storing the solid reactant due to the generated gas could be avoided.

In practice, the hydrogen generation device 100 of one embodiment further includes a pump 140. The pump 140 is connected with the guide structure 130 to guide the reaction solution 50a to the porous structure 120. It is noted that, however, this specific arrangement should not be regarded as limiting. Rather, the reaction solution could be guided in another manner, for example, as illustrated in the embodiment below with reference to FIG. 2.

FIG. 2 illustrates a hydrogen generation device according to another embodiment of the invention. Referring to FIG. 2, the hydrogen generation device 200 of the embodiment includes a tank 210, a porous structure 220, and a guide structure 230. The construction and function of the tank 210, porous structure 220 and guide structure 230 are similar to those of the tank 110, porous structure 120, and guide structure 130 in the above embodiment explanatorily shown in FIG. 1. Therefore, explanations thereof are not repeated herein.

In the embodiment explanatorily shown in FIG. 2, the hydrogen generation device 200 further includes a pressurization device 240. The pressurization device 240 is connected with the tank 210 to pressurize the tank 210 such that the reaction solution 50b is delivered from the tank 210 to the porous structure 220 through the guide structure 230.

In addition, the hydrogen generation device 200 further includes a spray device 250. The spray device 250 is disposed at an end of the guide structure 230. The reaction solution 50b is sprayed to the porous structure 220 through the spray device 250, such that the reaction solution 50b could more uniformly permeate into the porous structure 220 to react with the solid reactant 60b.

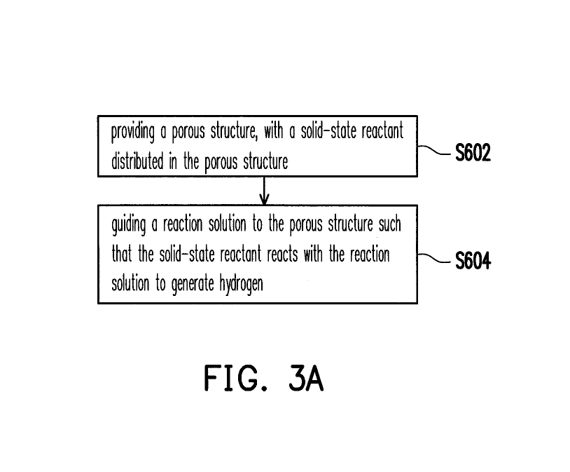

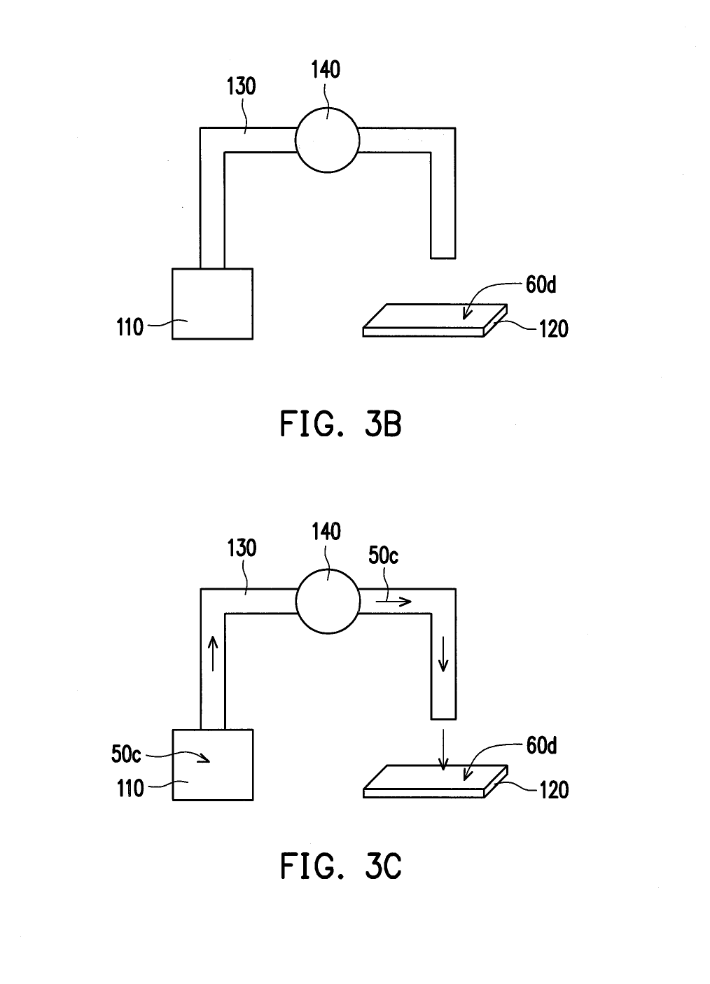

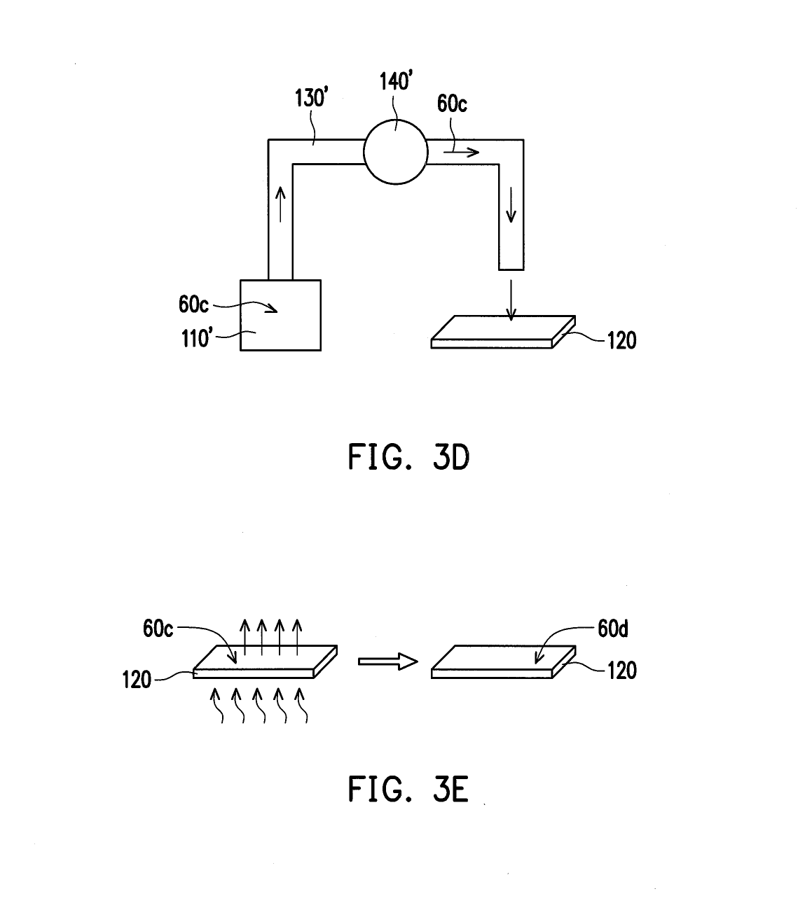

The following description and relevant Figures explain a hydrogen generation method according to one embodiment of the invention. FIG. 3A is a flow chart of a hydrogen generation method. FIGS. 3B to 3C illustrate a process of generating hydrogen by the hydrogen generation device of FIG. 1. Similar process may also be applied in the embodiment of FIG. 2. FIGS. 3D to 3E illustrate a process of distributing the solid reactant into the porous structure. As shown in FIG. 3A, the hydrogen generation method of the embodiment includes the following steps:

Step S602: providing a porous structure 120, with a solid reactant distributed in the porous structure 120; and

Step S604: guiding a reaction solution 50c to the porous structure 120 such that the solid reactant 60d reacts with the reaction solution 50c to generate hydrogen.

At step S602, in order to distribute the solid reactant 60d into the porous structure 120, the following method may be included (referring to FIGS. 3D to 3E): guiding a reaction solution 60c (which will be described hereafter) into the porous structure 120; and heating the porous structure 120 such that the solid reactant 60d precipitates from the reaction solution 60c. This solid reactant 60d is the same as the solid reactant 60a in FIG. 1. Using this method with a system similar to FIG. 1, the solid reactant 60d could be distributed in the porous structure 120. Specifically, when guiding the solution 60c to the porous structure 120, the solution 60c may first be contained in the tank 110′ and then be guided to the porous structure 120 through the guide structure 130′ connected with the tank 110′. A pump 140′ may also be used in this system to deliver the solution 60c. In the process of heating the porous structure 120, an anti-splashing layer (not shown) may cover the porous structure 120 to prevent the precipitated solid reactant 60d from splashing out of the porous structure 120. Other method may also be used to provide the reaction solution 60c to the porous structure 120, such as immersing the porous structure 120 directly into the reaction solution 60c.

Particularly, the solution 60c used to precipitate the solid reactant 60d may be a solution obtained by dissolving sodium borohydride (NaBH₄) in liquid ammonia (NH₃) or dissolving NaBH₄ in water. When the porous structure 120 is heated to make the solid reactant 60d be precipitated from the solution 60c, the liquid NH₃ or water used for the solution 60c is evaporated by heat and leaves the solid NaBH₄ distributed in the porous structure 120 (e.g. distributed in the pores) in the form of powder, particle, crystal or other forms. Solid magnesium hydride (MgH₂), calcium hydride (CaH₂), or aluminium (Al) powder may also be distributed in the porous structure 120 in a similar manner.

When the reaction solution 50c is guided to the porous structure 120 at step S604, the reaction solution 50c may be contained in the tank 110 and then guided to the porous structure 120 through the guide structure 130 connected with the tank 110. In the embodiment, the reaction solution 50c is used to react with the solid reactant 60d to generate hydrogen. The reaction solution 50c may be, for example, cobalt chloride (CoCl₂) solution, iron chloride (FeCl₂) solution, cobalt sulfate (CoSO₄) solution, nickel chloride (NiCl₂) solution, or other solutions that contain catalyst and could react with the solid reactant 60d to generate hydrogen. However, these specific examples should not be regarded as limiting. Rather, in other embodiments, the reaction solution 50c may, for example, be liquid water, malic acid, citric acid, sulfuric acid (H₂SO₄), sodium bicarbonate (NaHCO₃) solution, or calcium carbonate (CaCO₃) solution.

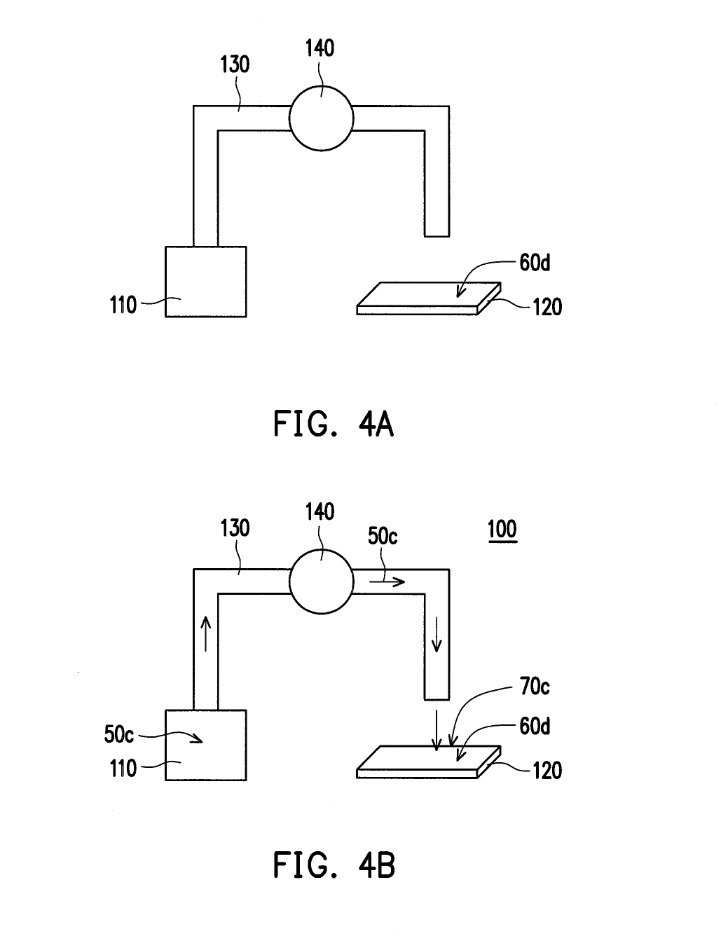

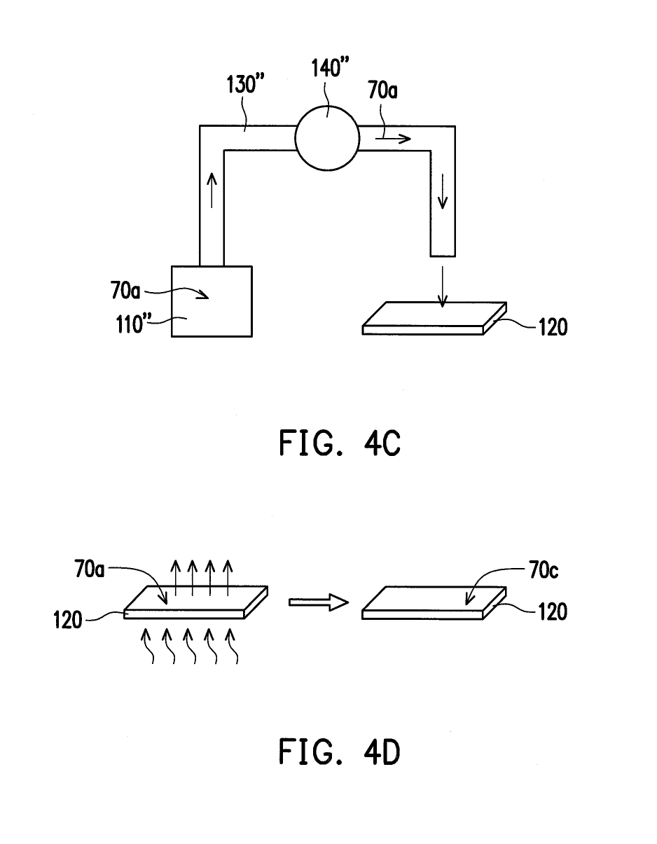

FIGS. 4A and 4B illustrates another process of generating hydrogen using the hydrogen generation device of FIG. 1. Referring to FIGS. 4A and 4B, in the embodiment, in generating the hydrogen, the same steps as steps S602 and S604 in FIG. 3A are performed, i.e. providing a porous structure 120, with a solid reactant distributed in the porous structure 120; and guiding a reaction solution 50c to the porous structure 120 such that the solid reactant 60d reacts with the reaction solution 50c to generate hydrogen. The present embodiment is different from the previous embodiment in that: in addition to the solid reactant 60d distributed in the porous structure 120, there is also solid catalyst 70c distributed in the porous structure 120.

Since both the solid reactant 60d and the solid catalyst 70c are distributed in the porous structure 120, step S602 (providing the porous structure 120) further includes distributing the solid catalyst 70c in the porous structure 120. FIGS. 4C and 4D illustrate a process of distributing a solid catalyst in the porous structure using a system similar to FIG. 1. Referring to FIGS. 4C and 4D, the process includes guiding a catalyst solution 70a to the porous structure 120; and heating the porous structure 120 such that the solid catalyst 70c is precipitated from the catalyst solution 70a.

The catalyst solution 70a may be, for example, CoCl₂ solution, FeCl₂ solution, CoSO₄ solution, or NiCl₂ solution, which may generate solid catalyst 70c such as CoCl₂, FeCl₂, CoSO₄ or NiCl₂ by heating the catalyst solution 70a. When the catalyst solution 70a is guided to the porous structure 120, the catalyst solution 70a may be contained in the tank 110″ and then guided to the porous structure 120 through the guide structure 130″ connected with the tank 110″. A pump 140″ may also be used in this system to deliver the catalyst solution 70a. In the process of the heating the catalyst solution 70a, an anti-splashing layer (not shown) may cover the porous structure 120 to prevent the precipitated solid catalyst 70c from splashing out of the porous structure 120.

It should be understood that the sequence of distributing the solid reactant 60d and distributing the solid catalyst 70c in the porous structure 120 may be determined based on actual needs in practice. If distributing the solid catalyst 70c in the porous structure 120 is prior to distributing the solid reactant 60d in the porous structure 120 using the solution 60c, the solid reactant 60d are dissolved in a solvent that does not react with the solid reactant 60d to generate hydrogen, e.g. NaBH₄ is dissolved in low-concentration sodium hydroxide (NaOH) instead of water, for preventing hydrogen generation under catalysis while guiding the solution 60c to the porous structure 120 that contains the solid catalyst 70c.

Additionally, in the embodiment, since the solid catalyst 70c and solid reactant 60d are already distributed in the porous structure 120, the reaction solution 50c may be a solution that does not contain catalyst but could react with the solid reactant 60d to generate hydrogen, for example, liquid water, malic acid, citric acid, H₂SO₄, NaHCO₃ solution or CaCO₃ solution. Hydrogen generated through the reaction between the reaction solution 50c and the solid reactant 60d could likewise escape through the pores of the porous structure 120 for a fuel cell to generate electricity.

In summary, in embodiments of the invention, the solution containing solid reactant is guided to the porous structure and the porous structure is heated such that the solid reactant precipitates and is distributed in the porous structure in the form of powder or crystal. Therefore, when the reaction solution is guided to the porous structure, the reaction solution could directly react with the solid reactant distributed in the porous structure thus enhancing the hydrogen generation efficiency. Besides, the generated hydrogen could escape directly through the pores of the porous structure for the fuel cells to generate electricity.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A hydrogen generation device adapted for a fuel cell, the hydrogen generation device comprising:
a tank for containing a reaction solution;
a porous structure with a solid reactant distributed therein; and
a guide structure connected with the tank, wherein the guide structure is adapted to guide the reaction solution in the tank to the porous structure, such that the reaction solution reacts with the solid reactant to generate hydrogen.

2. The hydrogen generation device according to claim 1, further comprising a pressurization device, wherein the pressurization device is connected with the tank and adapted to pressurize the tank such that the reaction solution is delivered from the tank to the porous structure through the guide structure.

3. The hydrogen generation device according to claim 1, further comprising a spray device disposed at an end of the guide structure, wherein the spray device is adapted to spray the reaction solution on the porous structure.

4. The hydrogen generation device according to claim 1, wherein the solid reactant is distributed in pores of the porous structure.

5. The hydrogen generation device according to claim 1, wherein the reaction solution comprises liquid water, malic acid, citric acid, sulfuric acid, sodium bicarbonate solution, calcium carbonate solution, cobalt chloride solution, iron chloride solution, cobalt sulfate solution, or nickel chloride solution.

6. The hydrogen generation device according to claim 1, wherein the solid reactant comprises sodium borohydride, magnesium hydride, calcium hydride, or aluminum.

7. A hydrogen generation method comprising:
providing a porous structure with a solid reactant distributed in the porous structure; and
guiding a reaction solution to the porous structure such that the solid reactant reacts with the reaction solution to generate hydrogen.

8. The hydrogen generation method according to claim 7, wherein the solid reactant is distributed in pores of the porous structure.

9. The hydrogen generation method according to claim 7, wherein the step of providing the porous structure comprises:
guiding a solution to the porous structure; and
heating the porous structure such that the solution precipitates the solid reactant.

10. The hydrogen generation method according to claim 9, wherein the step of guiding the solution to the porous structure comprises:
containing the solution in a first tank;
providing a first guide structure connected with the first tank; and
guide the solution to the porous structure through the first guide structure.

11. The hydrogen generation method according to claim 9, wherein the solution comprises sodium hydroxide and sodium borohydride.

12. The hydrogen generation method according to claim 7, wherein the step of providing the porous structure comprises:
guiding a catalyst solution to the porous structure; and
heating the porous structure such that the catalyst solution precipitates a solid catalyst distributed in the porous structure.

13. The hydrogen generation method according to claim 12, wherein the step of guiding the catalyst solution to the porous structure comprises:
containing the catalyst solution in a second tank;
providing a second guide structure connected with the second tank; and
guiding the catalyst solution to the porous structure through the second guide structure.

14. The hydrogen generation method according to claim 12, wherein the catalyst solution comprises cobalt chloride solution, iron chloride solution, cobalt sulfate solution, or nickel chloride solution, and the solid catalyst comprises cobalt chloride, iron chloride, cobalt sulfate, or nickel chloride.

15. The hydrogen generation method according to claim 7, wherein the solid reactant comprises sodium borohydride, magnesium hydride, calcium hydride, or aluminum.

16. The hydrogen generation method according to claim 7, wherein the step of guiding the reaction solution to the porous structure comprises:
containing the reaction solution in a third tank;
providing a third guide structure connected with the third tank; and
guiding the reaction solution to the porous structure through the third guide structure.

17. The hydrogen generation method according to claim 7, wherein the reaction solution comprises liquid water, malic acid, citric acid, sulfuric acid, sodium bicarbonate solution, calcium carbonate solution, cobalt chloride solution, iron chloride solution, cobalt sulfate solution, or nickel chloride solution.

18. The hydrogen generation method according to claim 9, wherein the solution comprises liquid ammonia and sodium borohydride.
